(19) United States
(12) Patent Application Publication
(10) Pub. No.: US 2006/0017612 A1
(43) Pub. Date: Jan. 26, 2006

(54) Emergency reporting device

(76) Inventor: Yoshinori Nagatani, Kawasaki-shi (JP)

Correspondence Address: MCDERMOTT WILL & EMERY LLP, 600 13TH STREET, N.W., WASHINGTON, DC, 20005-3096, US

(21) Appl. No.: 11/186,934

(22) Filed: Jul. 22, 2005

(30) Foreign Application Priority Data
Jul. 22, 2004 (JP) P2004-213968

(51) Int. Cl. G01S 5/14; B60R 25/10

(52) U.S. Cl. 342/357.07; 340/426.19

(57) ABSTRACT

When an emergency report is generated in a bad signal receiving environment such as a town with concentrated buildings, an underground parking lot and indoor where the accuracy of position information acquired is deteriorated, an emergency reporting device 10 loaded in a vehicle 1 acquires the present position of the vehicle 1 using the network assistance GPS function of the cellular phone 30, and transmits it to an emergency reporting center 5 so that the position with high accuracy can be transmitted to the emergency reporting center 5.

### BACKGROUND OF THE INVENTION

1. Field of the Invention

This invention relates to an emergency reporting device for transmitting position information when an emergency report has been generated to a reporting destination.

2. Description of the Related Art

Conventionally, emergency reporting devices have been proposed which are loaded in e.g. a vehicle such as a motor car to transmit data such as a present position of the vehicle and a vehicle number to a reporting destination such as a police or emergency reporting center when a traffic accident or sudden illness occurs. Further, as such a kind of emergency reporting device, an emergency reporting device has also been proposed which is provided with a GPS (Global Positioning System) for acquiring the position information in place of a navigation device when the position information cannot be acquired because of its failure (for example, see JP-A-2003-123172).

A conventional emergency reporting device can acquire the position information with high accuracy in a place such as a suburb where a few buildings are located and at least four GPS satellites are located simultaneously in a field a vision. But the conventional emergency reporting device presents the following problem. Namely, in the place with a bad signal receiving environment not capable of receiving the radio wave from these number of satellites (for example, a town with concentrated buildings, an underground parking lot and indoor), the accuracy of the position information is deteriorated so that an accurate position cannot be reported to the reporting destination.

### SUMMARY OF THE INVENTION

An object of this invention is to provide an emergency reporting device-capable of reporting an accurate present position from an environment difficult to receive the radio wave from a positioning satellite when a state of emergency occurs.

This invention is an emergency reporting device for transmitting position information when an emergency report is generated, comprising: position information acquiring means for acquiring the position information on the basis of signals received from positioning satellites; and position information computing means for computing the position information on the basis of the signals received from the positioning satellites and satellite orbit information and time information acquired from a position information server accessed through a network.

In accordance with this configuration, even where an emergency report event occurs in a signal receiving environment (for example, a town with concentrated buildings, an underground parking lot and indoor) where the accuracy of the present position detected using the positioning satellites is deteriorated (where the emergency report button is depressed or the air bag device is operated), the satellite orbit information and time information from the position information server can be acquired using the present position detecting function (network assistance GPS function) of a cellular terminal, and so the present position can be computed on the basis of these items of information. Thus, even when a state of emergency occurs in the bad signal receiving environment, the position information with high accuracy can be reported to the emergency reporting destination.

In this invention, the position information acquiring means acquires the position information on the signals received from four or more positioning satellites, and the position information computing means acquires the position information on the basis of the signals received from three or less positioning satellites.

This invention further comprises means for acquiring a signal receiving environment referring to the position information when the emergency report is generated and a map database, and means for selecting either one of the position information acquiring means and the position information computing means on the basis of the signal receiving environment thus acquired. In accordance with this configuration, the signal receiving environment of the present position when an emergency report event occurs can be known from the map database in e.g. a navigation device. For this reason, the position information acquiring means or position information computing means can be adaptively selected according to the signal receiving environment to acquire or compute the position information.

In this invention, the position information acquiring means and the position information computing means commonly employ a receiver for receiving the signals from the positioning satellites outside the emergency reporting device. For this reason, the emergency reporting device is not required to provide with the receiver. This contribute to cost reduction.

In this invention, acquisition of the position information by the position information acquiring means is stopped and computation of the position information by the position computing means is carried out only when the emergency report is generated. In accordance with this configuration, the position information is unified to the position information computed by the position computing means so that the it is not necessary to operate the position information acquiring means within the emergency reporting device. This contributes to cost reduction.

In accordance with this invention, even where an emergency report event occurs in a signal receiving environment (for example, a town with concentrated buildings, an underground parking lot and indoor) where the accuracy of the present position detected using the positioning satellites is deteriorated (where the emergency report button is depressed or the air bag device is operated), the satellite orbit information and time information from the position information server can be acquired using the present position detecting function (network assistance GPS function) of a cellular terminal, and so the present position can be computed on the basis of these items of information. Thus, even when a state of emergency occurs in the bad signal receiving environment, the position information with high accuracy can be reported to the emergency reporting destination.

### BRIEF DESCRIPTION OF THE DRAWINGS

FIG. 1 is a block diagram showing the configuration of an emergency reporting system according to the first embodiment of this invention.

FIG. 2 is a flowchart for explaining the operation of the emergency reporting system according to the first embodiment of this invention.

FIG. 3 is a flowchart for explaining the operation of the emergency reporting system according to the second embodiment of this invention.

FIG. 4 is a block diagram showing the configuration of an emergency reporting system according to the third embodiment of this invention.

### DESCRIPTION OF THE PREFERRED EMBODIMENTS

### Embodiment 1

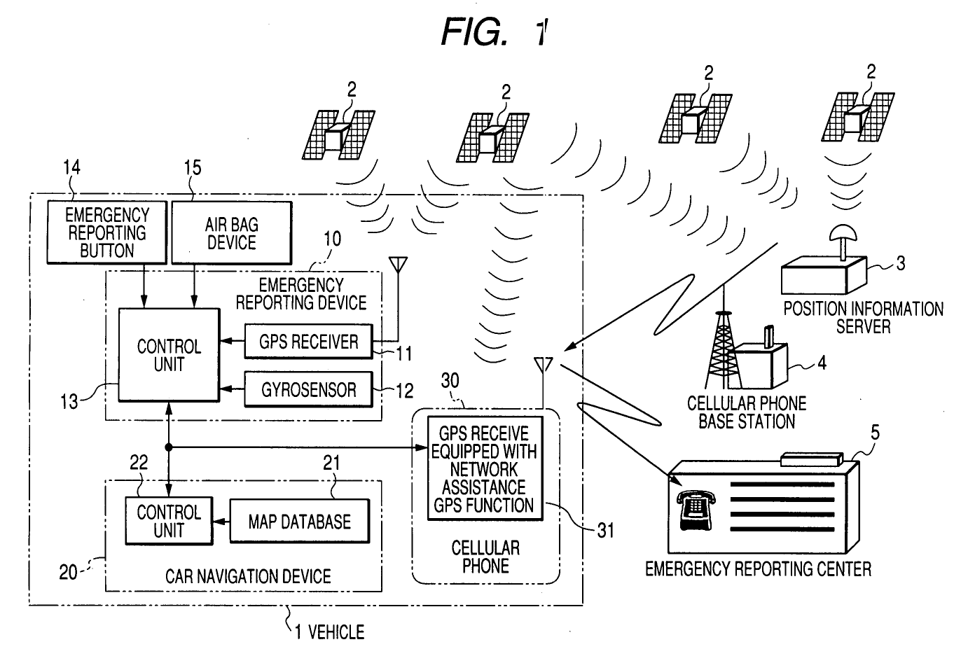

FIG. 1 is a block diagram showing the configuration of an emergency reporting system according to the first embodiment of this invention. The emergency reporting system according to this embodiment in FIG. 1 includes an emergency reporting device 10, a car navigation device 20, a cellular phone 30, a position information server 3 and a position reporting center 5. The emergency reporting device 10 and the car navigation device 20 are previously loaded in a vehicle 1. The cellular phone 30 is carried in the vehicle 1 by a user of the vehicle 1.

The emergency reporting device 10 includes a GPS receiver 11, a gyro-sensor 12 and a control unit 13 for controlling the respective components of the device. The GPS receiver 11 serves to receive the signals transmitted from four or more GPS satellites 2 among GPS satellites which are a plurality of positioning satellites constituting an overall earth positioning system, compute the present position on the basis of each received signal and produce the result of computation as the position information. The gyro-sensor 12 serves to produce the running orientation information indicative of the running orientation of the vehicle 1. Specifically, the gyro-sensor 12 causes a piezo-electric element to be repeatedly oscillated by voltage application. In this state, when an angular speed is applied to the piezo-electric element by rotational movement, Coriolis force is generated so that the piezo-electric element is slightly distorted. The gyro-sensor 12 takes out this distortion as the orientation information indicative of the running orientation.

Incidentally, in place of the GPS receiver 11, the receiver in a navigation satellite positioning system such as GLONASS (Global Navigation Satellite System which is a satellite navigation system run by Russia) may be provided.

An emergency reporting button 14 is a button used for asking for help when an accident or sudden illness occurs. When this button is operated, a switch signal which is an emergency reporting event is produced. The switch signal is supplied to the control unit 13 of the emergency reporting device 10. An air bag device 15 is ignited when the vehicle 1 has suffered from great shock thereby to operate an air bag so that a passenger(s) is protected from the shock. When the air bag is operated, an air bag operating signal which is an emergency reporting event is produced and supplied to the emergency reporting device 10.

The control unit 13 of the emergency reporting device 10 includes a CPU (central processing unit) not shown, a program memory in which a program for controlling the CPU is written, a work memory which is used in the operation of the CPU, an interface (interface means) used for connection to external devices, etc. In this embodiment, the emergency reporting button 14, air bag device 15, car navigation device 20 and cellular phone 30 are connected to the emergency reporting device 10.

The control unit 13 corrects the present position information from the GPS receiver 11 using the running orientation information from the gyro-sensor 12 to provide the position information with high accuracy, and supplies the position information to the car navigation device 20. This processing is carried out at predetermined timings from when power is turned on for the emergency reporting device 10 to when the power is turned off.

When the control unit 13 is supplied with the switch signal from the emergency reporting button 14 or air bag operating signal from the air bag device 15, it acquires the position information displayed on the car navigation device 20 and transmits the position information acquired to the emergency reporting center 5 using the communication function of the cellular phone 30. When the emergency reporting center 5 receives the position information transmitted from the cellular phone 30, it reports the position where the vehicle 1 has generated the emergency report to a police station and a firehouse, thereby performing assistance for rescue.

Where the vehicle 1 is located in the place capable of receiving the radio wave from only three or less GPS satellites 2 (a town with concentrated buildings, an underground parking lot, indoor, etc.), when the control unit 13 is supplied with the switch signal from the emergency reporting button 14 or air bag operating signal from the air bag device 15, it acquires the present position using a network assistance GPS function provided in the cellular phone 30 (function of acquiring the present position using the information transmitted from a position information server 3; particularly, the system for acquiring it on the side of the cellular phone is called “MS-Based Mode”), and transmits the position thus acquired to the emergency reporting center 5. When the emergency reporting center 5 receives the position information transmitted from the cellular phone 30, it reports the position where the vehicle 1 has generated the emergency report to the police station and firehouse, thereby performing assistance for rescue.

The car navigation device 20 includes a map database 21 in which map data are accumulated and a control unit 22 for performing path guiding processing on the basis of the map data accumulated in the map database 21 and the position information supplied from the emergency reporting device 10. The control unit 22 of the car navigation device 20 includes a CPU (central processing unit) not shown, a program memory in which a program for controlling the CPU is written, a work memory which is used in the operation of the CPU, an interface (interface means) used for connection to external devices, etc. In this embodiment, the emergency reporting device 10 is connected to the car navigation device 20.

The car navigation device 20 displays the present position of the vehicle 1 on the map on a display device not shown such as a liquid crystal display device by matching the present position supplied from the emergency reporting device 10 with the map database 21. Thus, a driver can know the position of his own vehicle by watching the display device.

The cellular phone 30 is provided with a GPS receiver 31 having the network assistance GPS function as well as the transmitter/receiver (not shown) used when it is employed as a general cellular phone. When the signals from the four or more GPS satellites 2 cannot be received, this network assistance GPS function serves to provide the present position by acquiring the satellite orbit information and time information necessary for positioning computation via a cellular phone network from the position information server 3. The cellular phone 30 is provided with an interface for connection to external devices, through which the emergency reporting device 10 employs the positioning system function of the cellular phone 30.

The positioning information server 3 serves to receive the signals transmitted from four or more GPS satellites 2 among GPS satellites which are a plurality of positioning satellites constituting an overall earth positioning system, analyze each of the signals to acquire the satellite orbit information and time information necessary for positioning computation in the emergency reporting device 10 and when required by the emergency reporting device 10, transmit these items of information to the cellular phone 30 of the vehicle 1 via a cellular phone base station 4. The GPS receiver 31 of the cellular phone 30 acquires the present position on the basis of the satellite orbit information and time information transmitted from the position information server 3.

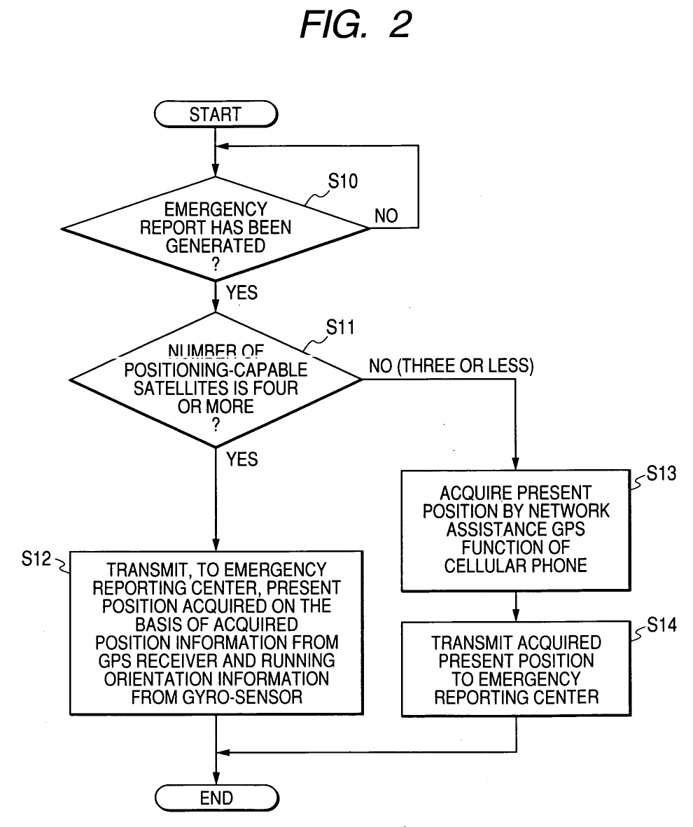

Now referring to the flowchart of FIG. 2, an explanation will be given of the operation of the emergency reporting system having the configuration described above. It is assumed that the main part of the operation is the control unit 13 of the emergency reporting device 10, and hereinafter simply referred to as the control unit 13. First, the control unit 13 determines whether or not an emergency report has been generated (step S10). Namely, the control unit 13 determines whether or not the switch signal from the emergency reporting button 14 or the air bag operating signal from the air bag device 15 has been inputted. In this determination, if neither switch signal nor air bag operating signal has been inputted, this step is repeated. If either one has been inputted, the operation proceeds to the subsequent step. The control unit 13 determines whether or not the number of the positioning-capable satellites is four or more (step S11). Namely, the control unit 13 determines the result of the counted number of the positioning-capable satellites of the GPS satellites 2 which are presently located in the field of vision of the GPS 11.

In the determination of step S11, if the number of the positioning-capable satellites is four or more, the control unit 13 transmits, to the emergency reporting center 5, the position information displayed by the car navigation device 20, i.e. the position information acquired on the basis of the position information from the GPS receiver 11 and running orientation information from the gyro-sensor 12 using the communication function of the cellular phone 30 (step S12). On the other hand, if the number of the positioning-capable satellites is three or less, the control unit 13 acquires the present position using the network assistance GPS function of the cellular phone 30 (step S13). The control unit 13 transmits the acquired position information to the emergency reporting center 5 using the communication function of the cellular phone 30 (step S14).

As described above, in accordance with the emergency reporting system according to this embodiment, when the emergency reporting device 10 generates the emergency report at the place with a bad signal receiving environment where the signals from four or more GPS satellites 2 cannot be received, the present position is acquired using the network assistance GPS function of the cellular telephone 30 in place of the positioning by the GPS receiver 11, and the position information therefor is transmitted to the emergency reporting center 5. For this reason, in any signal receiving environment, the position information with high accuracy can be transmitted to the emergency reporting center 5 so that the vehicle which has generated the emergency report can be found or located in a short time and surely.

### Embodiment 2

In the emergency reporting system according to the first embodiment, the system for acquiring the position information has been changed on the basis of the number of receivable satellites. Specifically, if the number of receivable satellites is four or more, the position information is acquired on the basis of the position information from the GPS receiver 11 and the running orientation information from the gyro-sensor 12, whereas if it is three or less, the position information is acquired using the network assistance GPS function of the cellular phone 30. On the other hand, in the emergency reporting system according to this second embodiment, the system of acquiring the position information is changed on the basis of the information from the car navigation device 20 when the emergency report has been generated.

Where the position of the vehicle 1 on the map database 21 of the car navigation device 20 when the emergency report has been generated is matched with the place such as a town with concentrated buildings, an underground parking lot and indoor where the position information with low accuracy is given by the use of the GPS receiver 11, the position information is acquired using the network assistance GPS function of the cellular phone 30. On the other hand, where the position of the vehicle 1 is matched with the place such as the rural district or suburbs where few shelters are located and so four or more GPS satellites 2 can be located within the field of vision, the position information is acquired on the basis of the position information from the GPS receiver 11 and the running orientation information from the gyro-sensor 12.

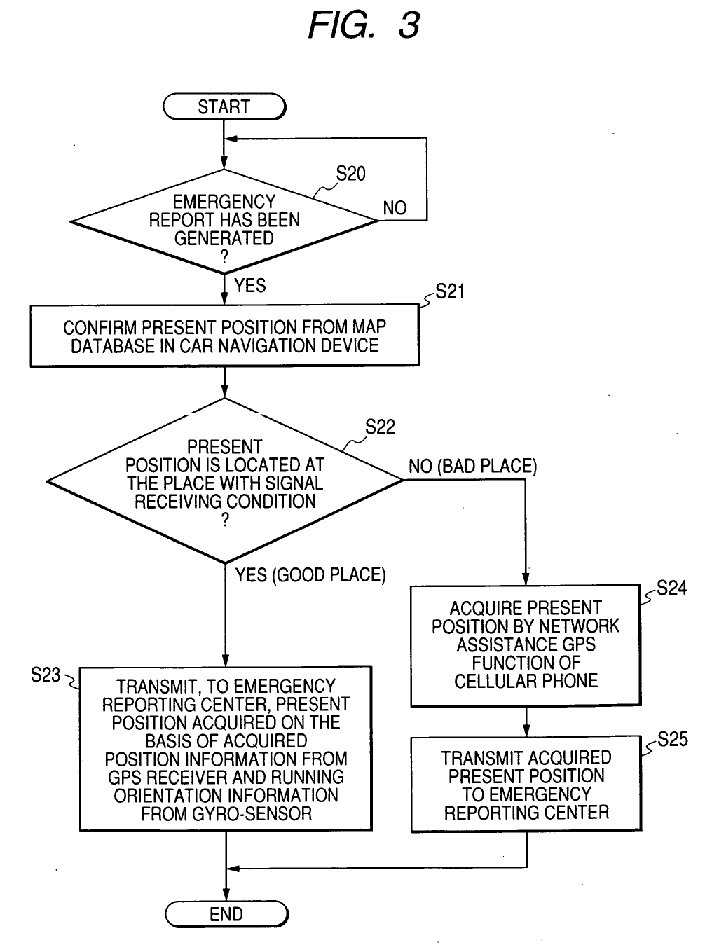

The above contents can be described in the flowchart of FIG. 3. First, the control unit 13 of the emergency reporting device 10 determines whether or not an emergency report has been generated (step S20). Namely, the control unit 13 determines whether or not the switch signal from the emergency reporting button 14 or the air bag operating signal from the air bag device 15 has been inputted. In this determination, if neither switch signal nor air bag operating signal has been inputted, this step is repeated. If either one has been inputted, the operation proceeds to the subsequent step. The control unit 13 confirms the present position from the map database 21 of the car navigation device 20 (step S21).

If the present position confirmed from the map database 21 is in the place with a good signal receiving condition, i.e. the place such as the rural district or suburbs where few shelters are located and so four or more GPS satellites 2 can be located within the field of vision, the control unit 13 acquires the position information displayed by the car navigation device 20, that is, the position information on the basis of the position information from the GPS receiver 11 and the running orientation information from the gyro-sensor 12 and transmits it to the emergency reporting center 5 using the communication function of the cellular phone 30 (step S23).

On the other hand, if the present position confirmed from the map database 21 is in the place with a bad signal receiving condition, i.e. the place such as a town with concentrated buildings, an underground parking lot and indoor where the position information with low accuracy is given by the use of the GPS receiver 11, the control unit 13 acquires the position information using the network assistance GPS function of the cellular phone 30 (step S24). The control unit 13 transmits the acquired position information to the emergency reporting center 5 using the communication function of the cellular phone 30 (step S25).

As described above, in accordance with the emergency reporting system according to this embodiment, when the emergency report is generated, on the basis of the information from the car navigation device 20, if the vehicle 1 is located in the bad signal receiving environment such as a town with concentrated buildings, an underground parking lot and indoor where the position information with low accuracy is given by the use of the GPS receiver 11, the position information is acquired using the network assistance GPS function of the cellular phone 30; and on the other hand, if the vehicle 1 is located at the place such as the rural district or suburbs where few shelters are located and so four or more GPS satellites 2 can be located within the field of vision, the position information is acquired on the basis of the position information from the GPS receiver 11 and the running orientation information from the gyro-sensor 12. For this reason, even in any signal receiving environment, the position information with high accuracy can be transmitted to the emergency reporting center 5 so that the vehicle which has generated the emergency report can be found or located in a short time and surely.

Incidentally, in this embodiment, in any case other than the bad signal receiving environment, the present position has been detected by the GPS receiver 11 regardless of the emergency report. But this GPS receiver 11, if it does not continue to acquire the position information at all times, cannot the position information with high accuracy. So the GPS receiver 11 must be operated at all times. This makes it difficult to save power. In order to obviate such an inconvenience, if only the GPS receiver 31 of the cellular phone 30 is used, positioning is not required except when the emergency report has been generated. This enables power saving. Namely, the cellular phone 30 is given the information for acquiring the present position from the position information server 3 through the network assistance GPS function, and so is not required to acquire the position at all times.

In each of the embodiments described above, the emergency reporting device 10 provided with both GPS receiver 11 and gyro-sensor 12 was employed. However by employing the GPS receiver and gyro-sensor loaded on the car navigation device, the GPS receiver 11 and gyro-sensor 12 can be omitted. This enables considerable cost reduction. It should be noted that if the GPS receiver 11 and the gyro-sensor 12 are not omitted from the emergency reporting device 10, when one is broken, the other can be employed so that the reliability of the emergency reporting system can be improved.

Further, the emergency reporting device 10, car navigation device 20 and cellular phone 30 have various configurations, respectively. However, as long as the present position can be acquired using the GPS satellites 2 and using the network assistance GPS function of the cellular phone 30, any configuration can be adopted.

### Embodiment 3

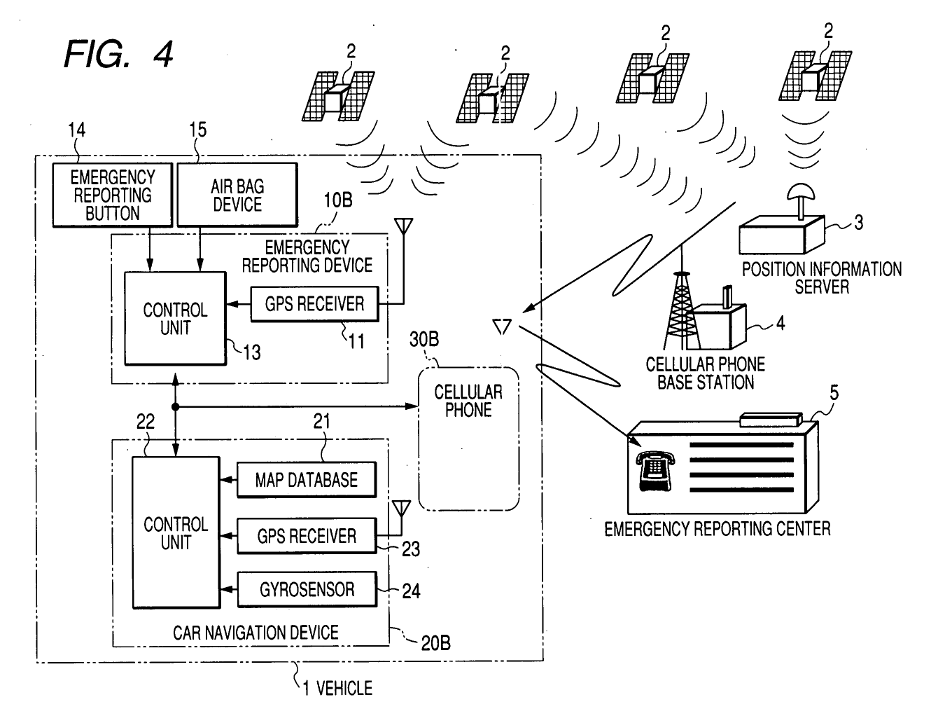

FIG. 4 is a block diagram showing the configuration of an emergency reporting system according to the third embodiment of this invention. In this embodiment, like reference symbols refer to components with like functions in the emergency reporting system according to the first embodiment. The emergency reporting system according to this embodiment includes an emergency reporting device 10B not provided with the gyro-sensor, a car navigation device 20B provided with a GPS receiver 23 and a gyro-sensor 24 and a cellular phone 30B provided with no GPS receiver but only with the network assistance GPS function.

The control unit 13 of the emergency reporting device 10B acquires the position information on the basis of the position information from the GPS receiver 11 and the running orientation information from the gyro-sensor 12 of the car navigation device 20B. In this embodiment also, when the emergency report is generated where the number of positioning-capable satellites is three or less, or at the place with the bad signal receiving condition, the position information is acquired using the network assistance GPS function of the cellular phone 30 and transmitted to the emergency reporting center 5.

Even where an emergency report event occurs in a signal receiving environment (for example, a town with concentrated buildings, an underground parking lot and indoor) where the accuracy of the present position detected using the positioning satellites is deteriorated (where the emergency reporting button is depressed or the air bag device is operated), the emergency reporting device according to this invention can acquire the satellite orbit information and time information from the position information server using the present position detecting function (network assistance GPS function) of a cellular terminal and compute the present position on the basis of these items of information. Thus, even when a state of emergency occurs in the bad signal receiving environment, the position information with high accuracy can be reported to the emergency reporting destination. For this reason, this invention is useful as an emergency reporting device for reporting the position information when the emergency report is generated to the reporting destination.

What is claimed is:

1. An emergency reporting device for transmitting to a reporting destination position information when an emergency report is generated, comprising:
a first acquirer, acquiring the position information on the basis of signals received from positioning satellites; and
a position information computer, computing the position information on the basis of the signals received from the positioning satellites and satellite orbit information and time information acquired from a position information server accessed through a network.

2. The emergency reporting device according to claim 1, wherein the first acquirer acquires the position information on the signals received from four or more positioning satellites, and the position information computer acquires the position information on the basis of the signals received from three or less positioning satellites.

3. The emergency reporting device according to claim 1 or 2, further comprising:
a second acquirer, acquiring a signal receiving environment referring to the position information when the emergency report is generated and a map database; and
a selector, selecting either one of the first acquirer and the position information computer based on the acquired signal receiving environment.

4. The emergency reporting device according to claim 1 or 2, wherein the first acquirer and the position information computer commonly employ a receiver for receiving the signals from the positioning satellites outside the emergency reporting device.

5. The emergency reporting device according to claim 1 or 2, wherein acquisition of the position information by the first acquirer is stopped and computation of the position information by the position computer is carried out only when the emergency report is generated.
